(19) United States
(12) Patent Application Publication
(10) Pub. No.: US 2013/0114202 A1
(43) Pub. Date: May 9, 2013

(54) MOUNTING APPARATUS FOR MULTIPLE HARD DISK DRIVES AND ELECTRONIC DEVICE HAVING THE SAME

(71) Applicants: CHIEH-HSIANG LIN, Tu-Cheng (TW); HUANG-JYUN LU, Tu-Cheng (TW)

(72) Inventors: CHIEH-HSIANG LIN, Tu-Cheng (TW); HUANG-JYUN LU, Tu-Cheng (TW)

(73) Assignee: HON HAI PRECISION INDUSTRY CO., LTD., Tu-Cheng (TW)

(21) Appl. No.: 13/316,468

(22) Filed: Dec. 10, 2011

(30) Foreign Application Priority Data
Nov. 4, 2011 (TW) 100140255

(51) Int. Cl. G06F 1/16

(52) U.S. Cl. 361/679.33

(57) ABSTRACT

A mounting apparatus for hard disk drives includes a plate. A number of spaced supporting portions is formed on at least one of two opposite side surfaces of the plate. A row of first latches extend upward from a top side of the plate. A row of second latches extend downward from a bottom side of the plate. Two fixing holes are respectively defined in the top and bottom sides of the plate. The mounting apparatus can be mounted between a bottom wall and a top wall of an electronic device, and has no bent plates, thus will save space for receiving more hard disk drives.

### BACKGROUND

1. Technical Field

The present disclosure relates to an electronic device having a mounting apparatus for hard disk drives (HDDs).

2. Description of Related Art

An electronic device generally includes hardware for mounting multiple HDDs. The hardware may include a vertical plate, and two bent plates respectively and perpendicularly extending from the top and the bottom of the vertical plate. The bent plates are respectively fixed to the top wall and the bottom wall of the electronic device by rivets or screws. A limited number of HDDs can being arranged in the electronic device between two adjacent mounting apparatus. However, the bent plates occupy too much space in the electronic device to allow addition of even more HDDs.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an exemplary embodiment of an electronic device, wherein the electronic device includes three mounting apparatus.

FIG. 2 is an assembled, isometric view of the electronic device of FIG. 1 together with three hard disk drives.

FIG. 3 is an enlarged view of a circled portion III of FIG. 1.

FIG. 4 is an enlarged view of one of the mounting apparatus of FIG. 1.

FIG. 5 is an enlarged view of a circled portion V of FIG. 4.

FIG. 6 is an enlarged view of a circled portion VI of FIG. 4.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

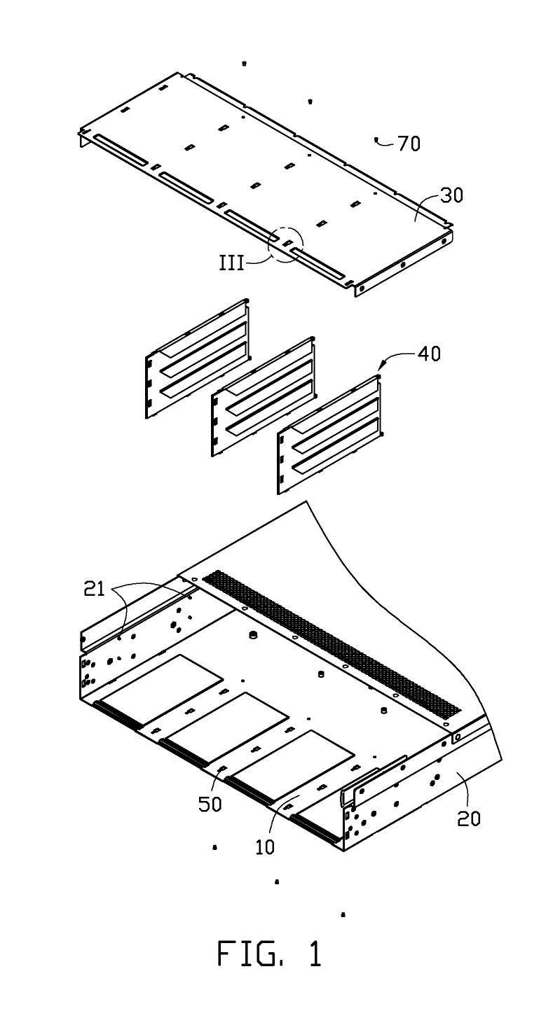

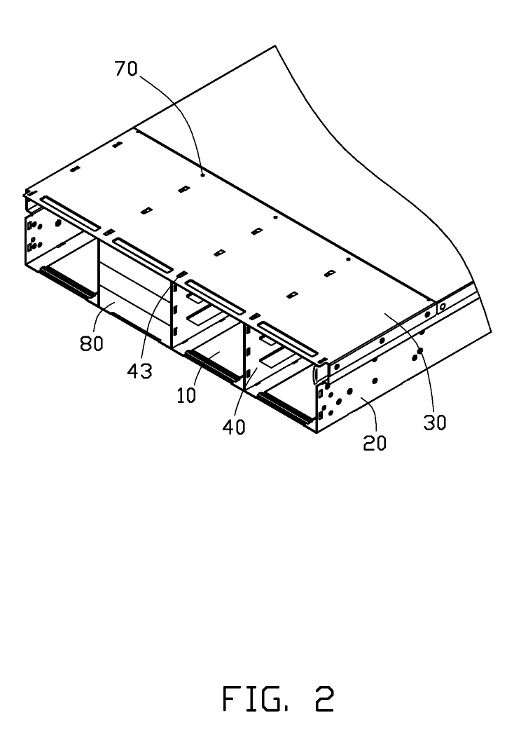

Referring to FIGS. 1 and 2, an exemplary embodiment of an electronic device includes a bottom wall 10, two sidewalls 20 perpendicularly extending up from opposite sides of the bottom wall 10, a top wall 30 detachably connected between tops of the sidewalls 20, and three mounting apparatus 40.

The bottom wall 10 is parallel to the top wall 30. Three rows of latching slots 50 parallel to the sidewalls 20 are defined in each of the bottom wall 10 and the top wall 30, with the latching slots 50 of the bottom wall 10 respectively aligning with the latching slots 50 of the top wall 30. Space between every two adjacent rows of latching slots 50 of each of the top and bottom wall 30 and 10, and space between each sidewall 20 and two corresponding rows of latching slots 50 adjacent to the sidewall 20 are substantially equal to a width of a hard disk drive 80. Two rows of spaced supporting portions 21 are formed on the inner surface of each sidewall 20, parallel to the bottom wall 10, to respectively support three hard disk drives 80 together with the bottom wall 10.

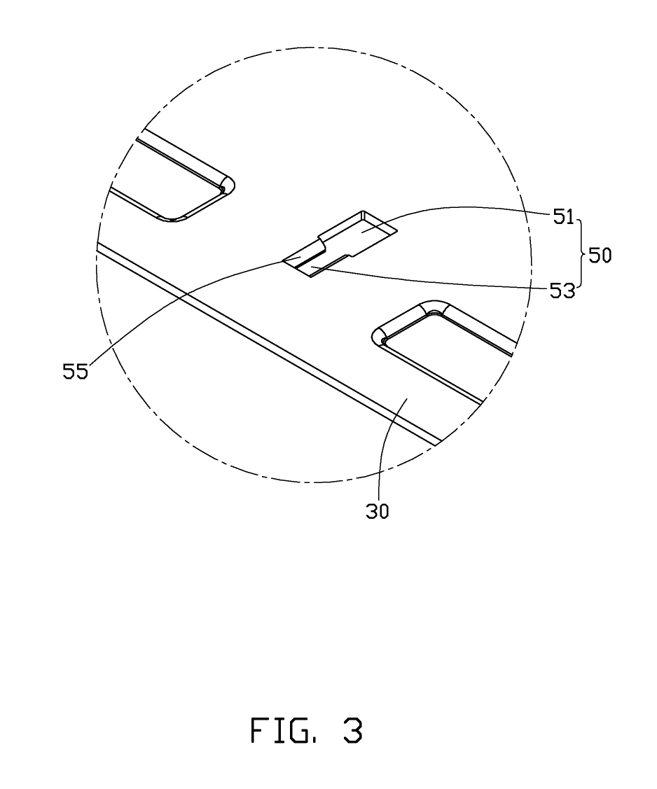

Referring to FIG. 3, each latching slot 50 includes a first hole 51, and a second hole 53 arranged in front of the first hole 51 and communicating with the first hole 51. A width of the second hole 53 is less than a width of the first hole 51. Two opposite sidewalls bounding each second hole 53 respectively forms two slanted first surfaces 55.

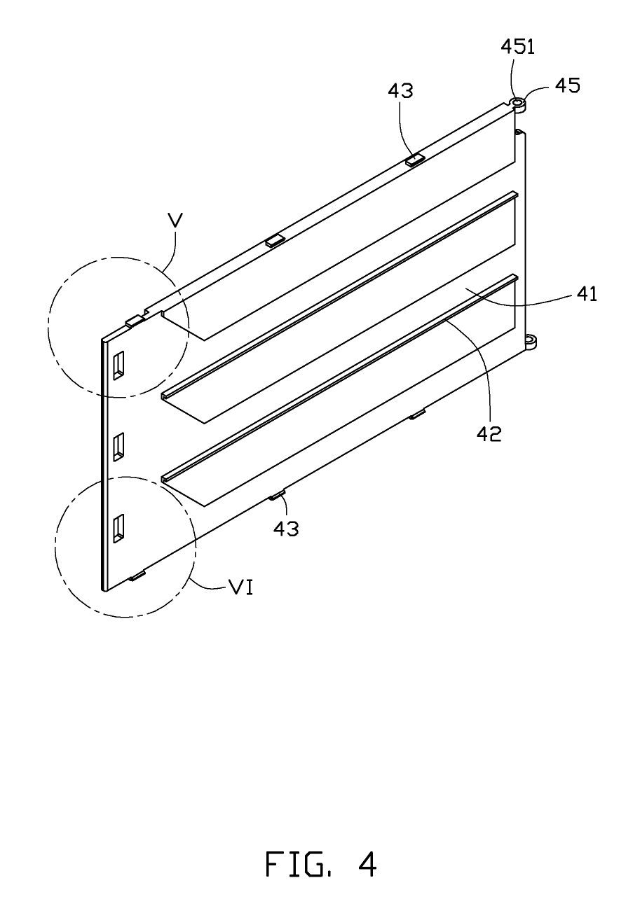

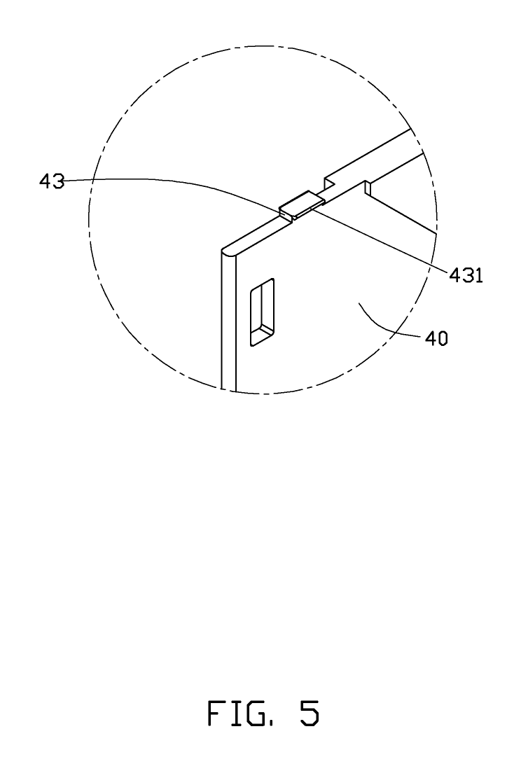

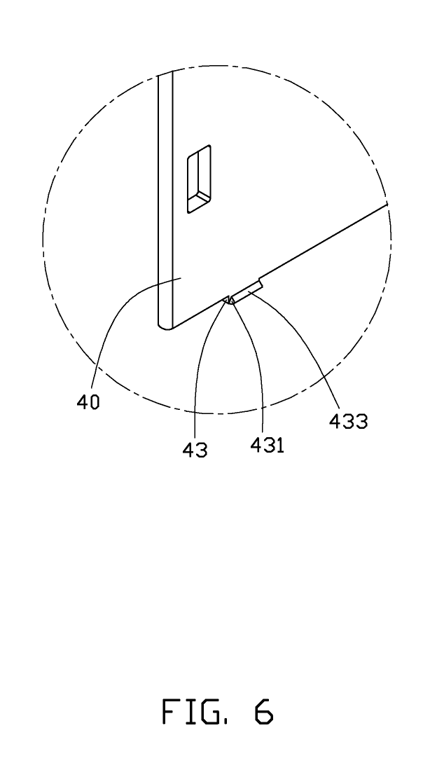

Referring to FIGS. 4 to 6, each mounting apparatus 40 includes a plate 41. A plurality of parallel supporting portions 42 is formed on each of the opposite sides of the plate 41, parallel to the bottom wall 10, to respectively support hard disk drives 80. Two rows of latches 43 respectively extend up and down from the top and the bottom of the plate 41, corresponding to two aligned rows of latching slots 50 of the top and bottom walls 30 and 10. Each latch 43 has a substantially T-shaped cross section, and includes two elongated flanges 431 respectively extending outward from opposite sides of a distal end of the latch 43 away from the plate 41. A slanted second surface 433 is formed on an end of each flange 431 facing the plate 41. Two fixing portions 45 respectively extend rearward from the top and the bottom of the rear end of the plate 41. A fixing hole 451 is defined in each fixing portion 45. In other embodiments, to save material, the fixing holes 451 can be directly defined in the top and the bottom of the plate 41.

Referring to FIG. 2, in assembly, the mounting apparatus 40 are arranged between the top wall 30 and the bottom wall 10, substantially perpendicular to the top wall 30 and the bottom wall 10. The row of latches 43 on the top of each mounting apparatus 40 are extended through a corresponding row of first holes 51 of the top wall 30. The mounting apparatus 40 are moved forwards, to allow the latches 43 on the top of each mounting apparatus 40 to engage in the corresponding second holes 53 of the top wall 30, and to allow the second surfaces 433 to slidably engage with the corresponding first surfaces 55. The tops of the latches 43 on the tops of the mounting apparatus 40 are coplanar with the outer surface of the top wall 30. A plurality of fasteners 70, such as rivets or screws, is extended through the top wall 30 and respectively engages in the fixing holes 451 of the tops of the mounting apparatus 40. Thereby, the mounting apparatus 40 are perpendicularly fixed to the inner surface of the top wall 30.

The row of latches 43 on the bottom of each mounting apparatus 40 are extended through a corresponding row of first holes 51 of the bottom wall 10. The mounting apparatus 40 are moved forwards, to allow the latches 43 on the bottom of each mounting apparatus 40 to engage in the corresponding second holes 53 of the bottom wall 10, and to allow the second slanted surfaces 433 to slidably engage with the corresponding first surfaces 55. The bottoms of the latches 43 on the bottoms of the mounting apparatus 40 are coplanar with the outer surface of the bottom wall 10. A plurality of fasteners 70, such as rivets or screws, is extended through the bottom wall 10 and respectively engages in the fixing holes 451 of the bottoms of the mounting apparatus 40. Thereby, the mounting apparatus 40 are perpendicularly fixed to the inner surface of the bottom wall 10.

A plurality of screws (not shown) is extended through the top wall 30 and engaged in the sidewalls 20, to fix the top wall 30 to the tops of the sidewalls 20. Thereby, the electronic device is assembled.

A plurality of hard disk drives 80 is inserted into the electronic device respectively between two adjacent mounting apparatus 40, and between each sidewall 20 and an adjacent mounting apparatus 40. Each hard disk drive 80 is supported on two corresponding supporting portions 42, or 21 and 42.

In the embodiment, the top and the bottom of each mounting apparatus 40 are respectively fixed to the top wall 30 and the bottom wall 10 through the upwards and downwards arranged latches 43. Because the mounting apparatus 40 have no bent plates, and will not occupy vertical stacking space of the electronic device, the electronic device can receive more hard disk drives.

Even though numerous characteristics and advantages of the embodiments have been set forth in the foregoing description, together with details of the structure and the functions of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A mounting apparatus for hard disk drives, comprising:
a plate;
a plurality of parallel supporting portions formed on at least one of two opposite side surfaces of the plate;
a row of first latches extending upward from a top side of the plate;
a row of second latches extending downward from a bottom side of the plate; and
two fixing holes respectively defined in the top and bottom sides of the plate.

2. The mounting apparatus of claim 1, wherein two fixing portions respectively extend rearward from rear ends of the top and bottom sides of the plate, the fixing holes are respectively defined in the fixing portions.

3. The mounting apparatus of claim 1, wherein each of the first and second latches has a substantially T-shaped cross section, and comprises two elongated flanges at a distal end away from the plate.

4. An electronic device, comprising:
a bottom wall defining two rows of first latching slots;
a top wall parallel to the bottom wall, and defining two rows of second latching slots respectively aligning with the rows of first latching slots;
two parallel mounting apparatus perpendicularly connected between the top and bottom walls, each mounting apparatus comprising a plate, a plurality of supporting portions formed on a side surface of the plate facing the opposite mounting apparatus, a row of first latches extending upward from a top side of the plate to engage in a corresponding one of the rows of first latching slots, a row of second latches extending downward from a bottom side of the plate to engage in a corresponding one of the rows of second latching slots, and two fixing holes respectively defined in the top and bottom sides of the plate;
four fasteners respectively extended through the top and bottom walls and engaging in the corresponding fixing holes of the mounting apparatus; and
a plurality of hard disk drives received in the electronic device between the mounting apparatus, wherein each of the hard disk drives is supported on two corresponding ones of the supporting portions of the mounting apparatus.

5. The electronic device of claim 4, wherein two fixing portions respectively extend rearward from rear ends of the top and bottom sides of a of each plate, the fixing holes of the mounting apparatus are respectively defined in the fixing portions.

6. The electronic device of claim 4, wherein each of the first and second latches has a substantially T-shaped cross section, and comprises two elongated flanges at a distal end away from the corresponding plate, each of the first and second latching slots comprises a first hole and a second hole arranged in front of the first hole and communicating with the first hole, a width of each second hole is less than a width of each first hole, the first and second latches are respectively extended through the first holes of the first and second latching slots, and then move towards the corresponding second holes, to allow the flanges to respectively engage with the sidewalls bounding the corresponding second holes.

7. The electronic device of claim 6, wherein the sidewalls bounding each second hole form two slanted first surfaces, a slanted second surface is formed on a side of each flange facing the corresponding plate, to engage with a corresponding one of the first surfaces.

8. An electronic device, comprising:
a bottom wall defining a row of first latching slots;
two sidewalls perpendicularly extending up from opposite sides of the bottom wall, wherein the row of first latching slots is parallel to the sidewalls, and a plurality of spaced first supporting portions parallel to the bottom wall is formed on one of the sidewalls;
a top wall detachably connected between tops of the sidewalls, the top wall defining a row of second latching slots aligning with the row of first latching slots;
a mounting apparatus comprising a plate, a row of first latches extending upward from a top side of the plate to engage in the row of first latching slots, a row of second latches extending downward from a bottom side of the plate to engage in the row of second latching slots, and a plurality of spaced second supporting portions parallel to the bottom wall formed on a side surface of the plate facing the first supporting portions;
two fasteners respectively extended through the top and bottom walls and engaging in the top and bottom sides of the mounting apparatus; and
a plurality of hard disk drives stacked in the electronic device between the mounting apparatus and the sidewall having the supporting portions, wherein each of the hard disk drives is supported on two corresponding supporting portions of the mounting apparatus and the sidewall.

9. The electronic device of claim 8, wherein two fixing portions respectively extend rearward from rear ends of the top and bottom sides of the plate, the fixing holes are respectively defined in the fixing portions.

10. The electronic device of claim 8, wherein each of the first and second latches has a substantially T-shaped cross section, and comprises two elongated flanges at a distal end away from the plate, each of the first and second latching slots comprises a first hole and a second hole arranged in front of the first hole and communicating with the first hole, a width of each second hole is less than a width of each first hole, the first and second latches are respectively extended through the first holes of the first and second latching slots, and then move towards the corresponding second holes, to allow the flanges to respectively engage with opposite sidewalls bounding the corresponding second holes.

11. The electronic device of claim 10, wherein the sidewalls bounding each second hole form two slanted first surfaces, a slanted second surface is formed on a side of each flange facing the plate, to engage with a corresponding one of the first surfaces.
